(19) United States
(12) Patent Application Publication
(10) Pub. No.: US 2006/0123699 A1
(43) Pub. Date: Jun. 15, 2006

(54) Greenhouse and method of cultivation under glass

(76) Inventors: Giulio Lo Presti, Viareggio (IT); Luca Menardi, Madonna Dell'Olmo (IT)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 10/532,797

(22) PCT Filed: Nov. 23, 2003
(86) PCT No.: PCT/IT03/00769

§ 371 Date: Dec. 22, 2005

(30) Foreign Application Priority Data
Nov. 29, 2002 (IT) T02002A001037

(51) Int. Cl. A01G 9/00

(52) U.S. Cl. 47/17

(57) ABSTRACT

A greenhouse (1) is provided with an air humidifier (10) and a condenser ((35): the humidifier (10) has a semi-permeable membrane, of the type which permits the passage of water vapour between opposite sides of the membrane if there is a vapour pressure gradient between the said sides. A flow of sea water (13) and a flow of air (14) taken from the outside are supplied to the humidifier (10) and sent to opposite sides of the membrane, in such a way that the flow of air (14) is humidified before being introduced into the greenhouse; the humidified air (30) is then condensed in the condenser (10) to produce condensate (36) to be used for irrigating the plants.

### TECHNICAL FIELD

The present invention relates to a greenhouse and to a method of cultivation under glass.

### BACKGROUND ART

As is known, greenhouses are closed environments, usually delimited by glazed walls, where plants are cultivated in special climatic conditions.

When greenhouses are installed in regions with a particularly dry and arid climate, the cultivation of most plants requires a considerable input of irrigation water, the provision of which can be a major problem in arid regions.

In coastal areas, it has been proposed that suitably desalinated sea water be used for irrigation: however, since the quantity of water required is usually large, as mentioned above, the installations required to produce fresh water from sea water are relatively complicated, expensive and bulky, and are therefore not suitable, for example, for the production of small greenhouses which are self-sufficient in terms of their fresh water requirement.

### DISCLOSURE OF INVENTION

An object of the present invention is therefore to provide a greenhouse and a cultivation method applicable to this greenhouse which enable the aforementioned problems to be overcome.

In particular, an object of the invention is to provide a greenhouse having an air humidifier which, by increasing the humidity of the air within the greenhouse, makes it possible to reduce the quantity of irrigation water required for the plants.

Another object of the invention is to provide a greenhouse which has an irrigation system in which the water required for irrigation is obtained, in a simple and economical way, from sea water.

The present invention therefore relates to a greenhouse and to a method of cultivation under glass as specified in the attached claims 1 and 13 respectively.

Preferred embodiments of the greenhouse and of the method of cultivation according to the invention are also specified, in dependent claims 2 to 12 and 14 to 23 respectively.

The greenhouse according to the invention and the method of cultivation made possible by this greenhouse resolve the aforementioned problems of the prior art. This is because the air introduced into the greenhouse has a high relative humidity, which may reach approximately 90%, and, if required, a temperature which may be significantly lower than the external temperature: in these conditions, the quantity of water required to irrigate the plants is considerably reduced. Moreover, the irrigation water is obtained, in a simple and economical way, from the sea water which is also used to humidify the air. Consequently, the greenhouse requires no external inputs of fresh water.

### BRIEF DESCRIPTION OF THE DRAWINGS

Further characteristics and advantages of the present invention will be made clear by the following description of a non-restrictive example of embodiment of the invention, with reference to the figures of the attached drawings, in which:

FIG. 1 is a schematic view of a greenhouse made according to the invention;

FIG. 2 is an enlarged schematic view of a humidifier used in the greenhouse of FIG. 1;

FIG. 3 is an enlarged schematic view of a detail of the humidifier of FIG. 2;

FIG. 4 is an enlarged partial schematic view of a condenser used in the greenhouse of FIG. 1.

### BEST MODE FOR CARRYING OUT THE INVENTION

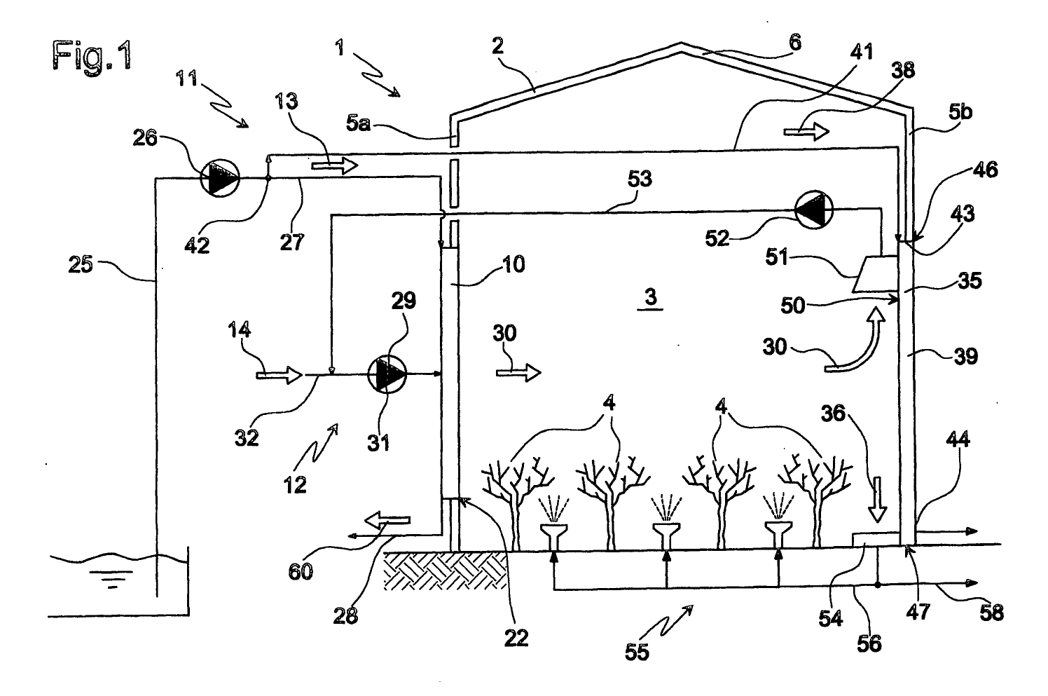

With reference to FIG. 1, a greenhouse 1 comprises a structure 2 delimiting a growing environment 3 in which plants 4 are placed. The structure 2 comprises lateral walls 5 which rise vertically from the ground, and a roof 6.

The greenhouse 1 comprises an air humidifier 10 and supply means 11 and 12 for bringing a flow of water 13 and a flow of air 14 respectively to the humidifier 10.

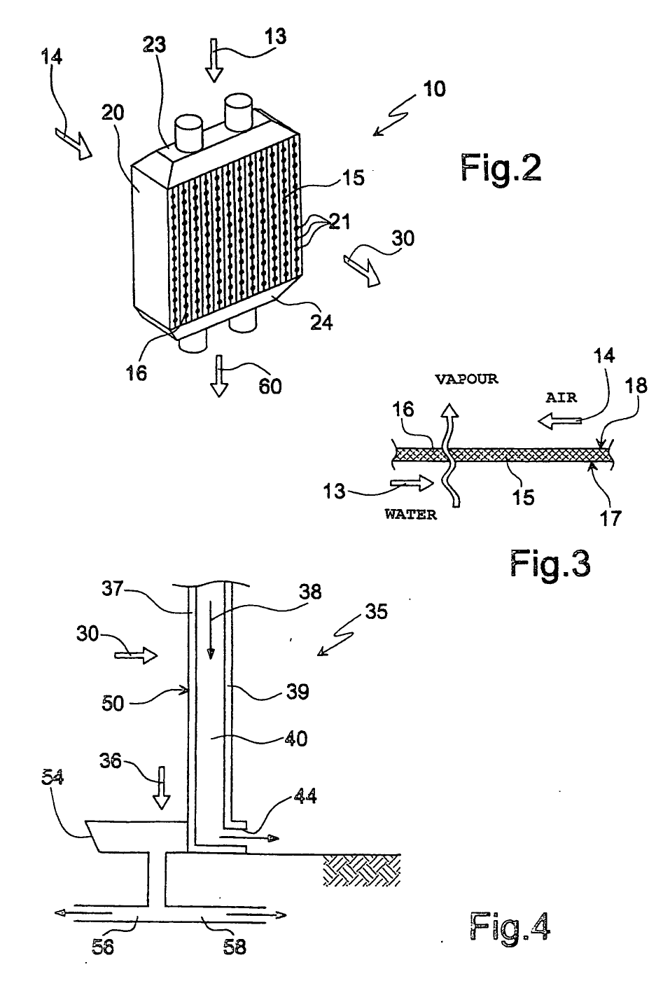

With additional reference to FIGS. 2 and 3, the humidifier 10 comprises at least one exchange element 15 having a semi-permeable membrane 16 which is of a known type and which allows water vapour to pass between its opposite sides 17 and 18, through the said membrane, if there is a vapour pressure gradient between these sides 17 and 18.

In particular, the membrane 16 which is used is of the type which allows the water vapour to pass in one direction only, but which retains the sea salts and other substances; if, therefore, the sides 17 and 18 of the membrane 16 are in contact, respectively, with a saline aqueous solution, for example sea water, and with a flow of air of low relative humidity, water vapour passes from the saline aqueous solution to the air flow, as shown schematically in FIG. 3.

Good results have been obtained by using polypropylene (PP) membranes having a water vapour resistance RET (determined according to UNI EN 31092) in the range from approximately 2 to approximately 5, preferably from approximately 3 to approximately 4, and in particular in the region of approximately 3.4 [10⁻² mbar m²/W]. It should be understood that other known membranes having similar characteristics to those quoted can be used.

In the non-restrictive present case which is illustrated, the humidifier 10 comprises a frame 20 which supports the membrane 16, this membrane 16 being shaped in such a way as to form a plurality of compartments 21, constituting corresponding exchange elements 15; each exchange element 15 is delimited by a portion of membrane 16 interposed between the flow of water 13 (sea water), circulating within the exchange element 15, and the flow of air 14, which is in contact with the exterior of the exchange element 15.

The frame 20 is accommodated in an open-ended housing 22 formed in a wall 5a of the greenhouse 1, and carries, at its opposing upper and lower ends respectively, an intake guide 23, which distributes the flow of water 13 to the exchange elements 15, and an outlet guide 24, which collects the water which has passed through the exchange elements 15.

The supply means 11 comprise a hydraulic circuit 25 provided with a circulation pump 26 to carry the flow of water 13 to the humidifier 10 and, in particular, into the exchange elements 15.

The hydraulic circuit 25 comprises an intake line 25 and an outlet line 28, positioned, respectively, up-line and down-line from the humidifier 10, and connected, respectively, to the intake guide 23 and to the outlet guide 24 of the humidifier 10. The flow of water 13 supplied to the humidifier 10 is a flow of salt water, particularly sea water or brackish water, drawn from the sea at a suitable depth by means of the hydraulic circuit 25.

The supply means 12 comprise forced ventilation means 29 for carrying the air flow 14 to the humidifier 10 and for introducing humidified air 30 into the greenhouse 1; in the present case, the forced ventilation means 29 comprise a fan 31 by means of which the flow of air 14 is taken from outside the greenhouse 1 and sent, through a delivery duct 32, to the humidifier 10 and, in particular, sent to make contact with the exterior of the exchange elements 15.

The greenhouse 1 also comprises a condenser 35 for condensing the water vapour present in the humidified air 30 introduced into the greenhouse 1, to obtain condensate 36.

The condenser 35 comprises at least one heat exchange element 37 between the humidified air 30 taken from the growing environment 3 and a cooling fluid 38 having a temperature lower than the temperature of the humidified air 30.

In the present, non-restrictive, case illustrated in FIG. 1, and in greater detail in FIG. 4, the condenser 35 is incorporated in a wall 5b of the greenhouse 1, opposite the wall 5a provided with the humidifier 10: the condenser 35 and the humidifier 10 are therefore located at opposite ends of the greenhouse 1.

The wall 5b has at least one wall portion 39 having a cavity 40 in which the cooling fluid 38 circulates; the cooling fluid 38 suitably consists of a portion of the flow of water 13 taken up-line from the humidifier 10 and sent into the cavity 40 through a branch circuit 41; the branch circuit 41 is connected to the intake line 27 of the hydraulic circuit 25 by a connector 42. The cavity 40 is provided with an intake 43 and an outlet 44, positioned at opposite ends 46 and 47 respectively, located respectively at the top and the bottom, of the wall portion 39, for the cooling fluid 38.

An inner face 50 of the wall portion 38, facing the interior of the greenhouse 1, forms a heat exchange surface between the cooling fluid 38 circulating in the cavity 40 and the humidified air 30 present within the greenhouse 1 (in other words in the growing environment 3).

At the upper end 46 of the wall portion 39 and above the heat exchange surface 50 there is positioned a suction hood 51 provided with a fan 52 to create a forced circulation of air within the greenhouse 1 and, specifically, to carry the humidified air 30, introduced into the growing environment 3 through the humidifier 10, to the condenser 35, in other words into contact with the heat exchange surface 50. The hood 51 is connected by a recirculation duct 53 to the delivery duct 32.

At the lower end 47 of the wall portion 39 there is positioned a collector 54 to collect the condensate 36 which has formed on the exchange surface 50 and has fallen downwards under the effect of gravity; the collector 54 is connected to an irrigation system 55 of any known type (which, for the sake of simplicity, is not described or illustrated in detail) by a duct 56.

The greenhouse 1 is used for the application of the method of cultivation according to the invention as described below.

The flow of water 13 is taken from the sea and sent to the humidifier 10 by the hydraulic circuit 25; the flow of air 14 is drawn in from the outside and supplied to the humidifier 10 by the fan 31: the vapour pressure of the flow of air 14 is lower than the vapour pressure of the flow of water 13, and therefore water vapour passes in the humidifier 10 from the flow of water 13 to the flow of air 14 through the membrane 16.

Advantageously, the flow of water 13 is supplied to the humidifier 10 at a temperature lower than the temperature of the flow of air 14, in such a way as to cool, as well as humidify, the flow of air 14; the cooling of the flow of air 14 is further promoted by the latent heat of evaporation of the said flow of air 14.

The humidified air 30 introduced into the greenhouse 1 is moved by the fan 52 and brought to the condenser 35: the heat exchange between the humidified air 30 and the cooling fluid 38, whose temperature is lower than the temperature of the humidified air 30, causes the condensation of the water vapour present in the humidified air 30 on the exchange surface 53; the resulting condensate 36 is fresh water, which is collected by the collector 54 and sent to the irrigation system 55.

Any condensate 36 in excess of the amount required for irrigation can be drawn off by a branch 58 and stored or sent for other uses.

The fans 29 and 52 cause a forced circulation of the air in the greenhouse 1: the steps of humidification and condensation are therefore essentially carried out continuously and simultaneously in the humidifier 10 and in the condenser 35 respectively, at the opposite ends of the greenhouse 1.

After giving up some of its humidity, the air leaving the condenser 35 has a water vapour content in excess of that of the outside air and a relatively low temperature, and it is therefore recirculated by means of the recirculation duct 53 to the humidifier 10. In a possible variant which is not illustrated, this air, before being recirculated to the humidifier 10, is sent into a cavity formed under or within the roof 6, in such a way that it has a cooling and thermally insulating effect on the said roof 6.

A flow of salt water 60 with a high saline concentration is taken from the humidifier 10, and can be sent, for example, to a salt production plant, or to another desalination device for producing additional fresh water.

Finally, it is clear that the greenhouse and method of cultivation under glass described and illustrated herein can be modified and varied in numerous ways without departing from the present invention as defined in the attached claims.

1. A greenhouse comprising a structure delimiting a growing environment, and an air humidifier, the greenhouse being characterized in that the humidifier comprises at least one exchange element having a semi-permeable membrane, which allows water vapour to pass between opposite sides of the membrane if there is a vapour pressure gradient between the sides, and in that the greenhouse also comprises first and second supply means for bringing a flow of water arid a flow of air respectively into contact with the opposite sides of the membrane.

2. The greenhouse according to claim 1, characterized in that the first supply means comprises a hydraulic circuit for bringing the flow of water into contact with a first side of the membrane.

3. The greenhouse according to claim 1, characterized in that the flow of water is a flow of sea water.

4. The greenhouse according to claim 1, characterized in that the second supply means comprise forced ventilation means for bringing the flow of air into contact with a second side of the membrane and introducing the humidified air leaving the humidifier into the greenhouse.

5. The greenhouse according to claim 1, characterized in that the humidifier comprises a plurality of exchange elements, each exchange element being delimited by a portion of semi-permeable membrane interposed between the flow of water, circulating within the exchange element, and the flow of air, which is in contact with the exterior of the exchange element.

6. The greenhouse according to claim 5, characterized in that the semi-permeable membrane is shaped in such a way as to form a plurality of compartments constituting corresponding exchange elements, the compartments having the flow of water running within them and having the flow of air in contact with their exteriors.

7. The greenhouse according to claim 1, characterized in that it comprises a condenser for condensing the water vapour present in the humidified air introduced into the greenhouse and for obtaining condensate.

8. The greenhouse according to claim 7, characterized in that the condenser and the humidifier are positioned at opposite ends of the greenhouse, forced ventilation means being provided to keep the air in forced circulation between the ends of the greenhouse.

9. The greenhouse according to claim 7, characterized in that the condenser is connected to irrigation means for distributing the condensate to the plants placed in the greenhouse.

10. The greenhouse according to claim 7, characterized in that it comprises recirculation means (or recirculating the air leaving the condenser and supplying it to the humidifier.

11. The greenhouse according to claim 7, characterized in that the condenser comprises at least one heat exchange element between the humidified air taken from the greenhouse and a. cooling fluid having a temperature lower than the temperature of the humidified air within the greenhouse.

12. The greenhouse according to claim 11, characterized in that it comprises a branch circuit for taking the cooling fluid from the flow of water up-line from the sad humidifier.

13. A method of cultivation under glass, characterized in that it comprises the steps of:
providing a greenhouse with an air humidifier comprising at least one exchange element having a semi-permeable membrane which allows water vapour to pass between opposite sides of the membrane if there is a vapour pressure gradient between the sides;
humidifying a flow of air by the exchange of water vapour between a flow of water and the flow of air, the flow or air and the flow of water being brought into contact with opposite sides and respectively of the membrane;
introducing the humidified air leaving the humidifier into the greenhouse.

14. The method according to claim 13, further comprising a step of causing a forced circulation of the air in the greenhouse.

15. The method according to claim 13, characterized in that the flow of air is supplied to the humidifier with a vapour pressure lower than the vapour pressure of the flow of water.

16. The method according to claim 13, characterized in that the flow of water is supplied to the humidifier at a temperature lower than the temperature of the flow of air.

17. The method according to claim 13, characterized in that the flow of water is a flow of sea water.

18. The method according to claim 13, characterized in that it comprises a condensation step, in which the water vapour present in the humidified air introduced into the greenhouse is condensed in a condenser to produce condensate.

19. The method according to claim 18, characterized in that the condensation step comprises a step of heat exchange between the humidified air taken from the greenhouse and a cooling fluid having a temperature lower than the temperature of the & humidified air.

20. The method according to claim 19, characterized in that the cooling fluid is taken from the flow of water up-line from the humidifier.

21. The method according to claim 18, characterized in that the humidification step and the condensation step are carried out in an essentially continuous and simultaneous way at opposite ends of the greenhouse.

22. The method according to claim 18, characterized in that it comprises a step of irrigating the plants placed in the greenhouse with the condensate.

23. The method according to claim 18, characterized in that it comprises a recirculation step, in which the air leaving the condenser is collected and supplied to the humidifier.

24. The method according to claim 18, characterized in that the air leaving the condenser is sent to cool a roof of the greenhouse.
